(19) United States
(12) Patent Application Publication
(10) Pub. No.: US 2025/0318689 A1
(43) Pub. Date: Oct. 16, 2025

(54) Rib Preparation Tool

(71) Applicant: Dansons US, LLC, Scottsdale, AZ (US)

(72) Inventors: Garrett Matz, Scottsdale, AZ (US); Heath Darveau, Gilbert, AZ (US)

(73) Assignee: Dansons US, LLC, Scottsdale, AZ (US)

(21) Appl. No.: 18/636,142

(22) Filed: Apr. 15, 2024

(51) Int. Cl. A47J 43/18; A47J 43/28

(52) U.S. Cl. CPC A47J 43/18; A47J 43/283

(57) ABSTRACT

A rib preparation tool includes a first jaw having a concave lower surface and a second jaw having a convex upper surface. The first and second jaws are mounted for movement with respect to each other between an open position and a closed position, in which the lower surface of the first jaw overlies and nests with the upper surface of the second jaw. The lower surface of the first jaw has a non-smooth characteristic.

### FIELD

The present specification relates generally to cooking, and more particularly to hand tools for preparing ribs.

### BACKGROUND

Ribs are a popular meat for grilling and smoking. Ribs must be prepared carefully to produce a good meal. A crucial step in preparation involves removal of a membrane on the back of a rack of ribs.

This membrane lines the ribs and separates them from internal organs and other parts of the animal. Some butchers remove the membrane before sale, but others do not. Almost universally, however, cooks prefer to remove the membrane before grilling or smoking the ribs. Leaving the membrane on the ribs gives the meats a tough and chewy texture and prevents rubs, seasonings, smoke, and other flavors from penetrating the meat.

There are a few conventional methods of removing the membrane. In one method, cooks pull up a corner piece of the membrane from one side of the rib rack. Cooks will frequently slide a knife, such as a butter knife, under the membrane and across the width of the rack to lift an entire side of the membrane off the meat. Once the end of the membrane has been lifted, the cook pulls the rest of the membrane off the rack. However, the membrane is slippery. Some cooks grasp the membrane with a paper towel to increase grip on the membrane. Others continue to slide their knife between the membrane and the meat.

In another method, cooks slide a knife in between the membrane and the meat at an intermediate location between the ends of the rack, pulling up with the knife to create a pocket. The cook then slides his fingers into that pocket and pulls the membrane off the meat. The cook may use a paper towel to help grasp the membrane with this technique, too.

With either of these methods, the cook must be careful to not tear the membrane. He might tear it with the knife, or he may tear it with his own hands. Tearing the membrane is frustrating, because the cook has to restart the process to remove the remaining portion of the membrane. This becomes harder when there is less and less membrane remaining on the meat.

There is a need for a tool to remove the membrane from a rack of ribs.

### SUMMARY

In an embodiment, a rib preparation tool includes a first jaw having a concave lower surface and a second jaw having a convex upper surface. The first and second jaws are mounted for movement with respect to each other between an open position and a closed position, in which the lower surface of the first jaw overlies and nests with the upper surface of the second jaw. The lower surface of the first jaw has a non-smooth characteristic.

In embodiments, the lower surface of the first jaw presents a plurality of edges directed toward the upper surface of the second jaw. The upper surface of the second jaw has a smooth characteristic. The first jaw has a first medial wall and opposed first sidewalls depending from the first medial wall. The second jaw has a second medial wall and opposed first sidewalls depending from the second medial wall. In the closed position, the first sidewalls hang over the second sidewalls and terminate below the second sidewalls. The first jaw includes a first proximal end and an opposed first distal end, the second jaw includes a second proximal end and an opposed second distal end, and the second distal end projects beyond the first distal end. The second distal end includes a medial wall and opposed sidewalls flanking the medial wall, and the medial wall projects beyond the sidewalls.

In an embodiment, a rib preparation tool includes a first member including a first handle and a first jaw and a second member including a second handle and a second jaw. The first and second members are pivoted to each other to move the first and second jaws between open and closed positions with respect to each other. The first jaw has a non-smooth concave lower surface, and the second jaw has a convex upper surface. In the closed position of the first and second jaws, the lower surface overlies and nests with the upper surface.

In embodiments, the first jaw includes a plurality of spaced-apart slots. The first jaw includes a proximal end and an opposed distal end, and the slots are spaced apart transversely between the proximal and distal ends. The first jaw has a first medial wall and opposed first sidewalls depending from the first medial wall, and the second jaw has a second medial wall and opposed first sidewalls depending from the second medial wall. In the closed position, the first sidewalls hang over the second sides and terminate below the second sidewalls. The first jaw includes a first proximal end and an opposed first distal end, the second jaw includes a second proximal end and an opposed second distal end, and the second distal end projects beyond the first distal end. The lower surface of the first jaw presents a plurality of edges directed toward the upper surface of the second jaw. The upper surface of the second jaw has a smooth characteristic. A bias is disposed between the first and second members and biases the first and second jaws into the open position.

A rib preparation tool includes a first jaw having a non-smooth concave lower surface and a second jaw having a convex upper surface. The first and second jaws are both integrally formed to a common handle. The first and second jaws resiliently flex between an open position and a closed position in which the lower surface of the first jaw overlies and nests with the upper surface of the second jaw. The second jaw includes a tip which, in the closed position of the first and second jaws, projects beyond the first jaw and includes a central nose with a contoured profile edge having an upwardly-directed bevel.

In embodiments, the lower surface of the first jaw includes a plurality of spaced-apart ridges. The first jaw includes a proximal end and an opposed distal end, and the ridges are spaced apart transversely between the proximal and distal ends. The upper surface of the second jaw includes a plurality of spaced-apart ridges. The first jaw includes a first proximal end and an opposed first distal end, the ridges are spaced apart transversely between the first proximal and distal ends, the second jaw includes a second proximal end and an opposed second distal end, and the ridges are spaced apart transversely between the first proximal and distal ends. The first jaw includes a first proximal end and an opposed first distal end, the second jaw includes a second proximal end and an opposed second distal end, and the second distal end projects beyond the first distal end.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1 and 2 are top and bottom perspective views of a rib preparation tool in an open position;

FIGS. 3 and 4 are top and bottom perspective views of the rib preparation tool of FIG. 1 in a closed position;

FIG. 5 is a front elevation view of the rib preparation tool of FIG. 1 in a closed position;

FIGS. 6-9 are top front, top rear, bottom front, and bottom rear perspective views of a rib preparation tool in an open position;

FIGS. 10 and 11 are front and side elevation views of the rib preparation tool of FIG. 6;

FIGS. 12 and 13 are top and bottom plan views of the rib preparation tool of FIG. 6; and

FIGS. 14-16 are top front perspective, side elevation, and front elevation views of the rib preparation tool of FIG. 6.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

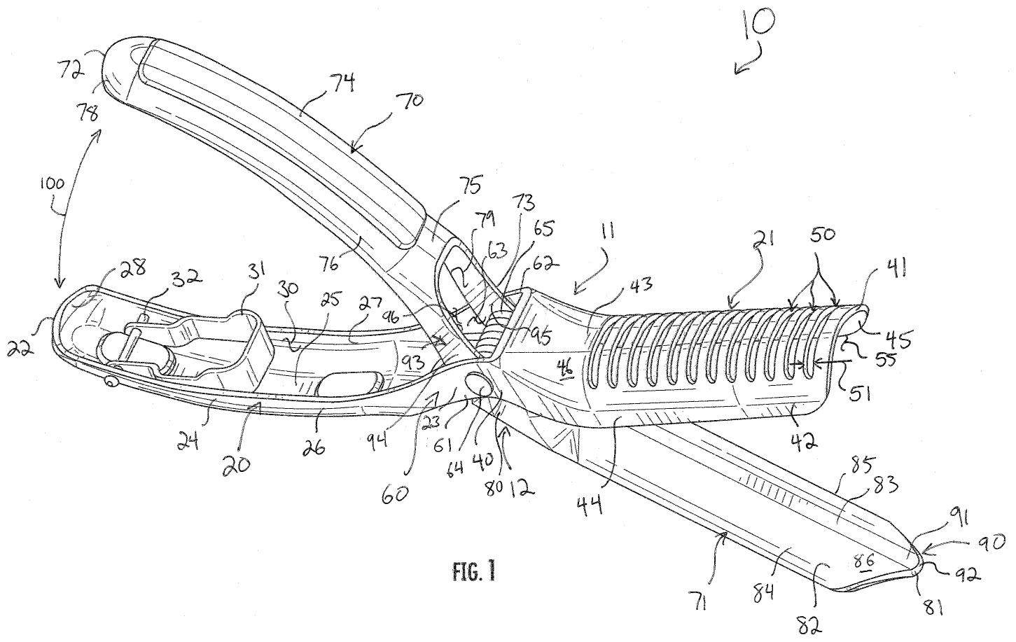

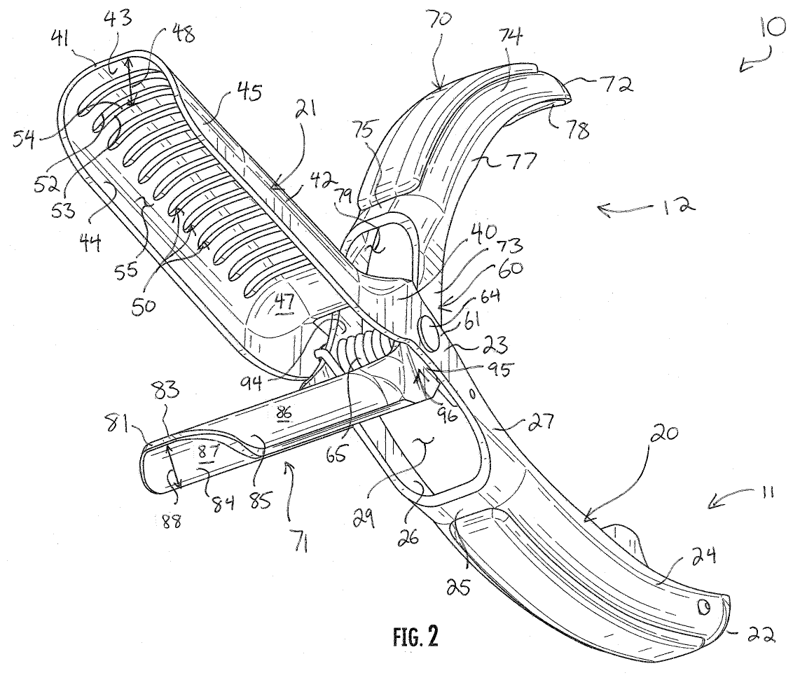

FIGS. 1 and 2 illustrate an embodiment of a rib preparation tool (hereinafter, the “rib prep tool 10” or just the “tool 10”) from alternate front perspective views, showing the tool 10 with its jaws in an open position. The tool 10 is preferably made of a rigid material, such as metal or plastic, and includes two main members pivoted to each other: a first member 11 and a second member 12. When a cook grasps the members 11 and 12 and squeezes them together, the tool 10 moves to close its jaws. A cook uses the tool 10 to easily slide under the membrane on a rack of ribs, grasp the membrane, and tear the membrane away from the rack, without slipping and without dirtying his fingers or wasting a paper towel.

The first member 11 overlies the second member 12 in the embodiment shown in these drawings. The first member 11 includes a handle portion or handle 20 at one end of the first member 11 and an opposed jaw portion or jaw 21 at an opposed end of the first member 11. The handle 20 and jaw 21 are preferably constructed from a single, integral, monolithic piece of material, such as a molded, extruded, stamped, or otherwise formed piece of plastic or metal.

The handle 20 is an elongate member extending from a proximal end 22 to a distal end 23. The handle 20 includes a single body 24 extending entirely from the proximal end 22 to the distal end 23. The body 24 has a medial wall 25 and opposed sidewalls 26 and 27 flanking the medial wall 25.

The medial wall 25 is a roughly flat wall extending along, and forming, a back of the handle 20. The medial wall 25 extends from the proximal end 22 but terminates short of the distal end 23. Offboard of the medial wall 25, between the medial wall 25 and the distal end 23 of the handle 20, is a gap 29, better seen in FIG. 2 than in FIG. 1.

The sidewalls 26 and 27 extend entirely from the proximal end 22 to the distal end 23 on either side of the medial wall 25. They are arranged roughly normal to the medial wall 25, though they are formed to the medial wall 25 with curved transitions therebetween. The sidewalls 26 and 27 are formed to an endwall 28 at the proximal end 22 of the handle 20. The sidewalls 26 and 27 and the endwall 28 all depend from the medial wall 25 by roughly the same distance.

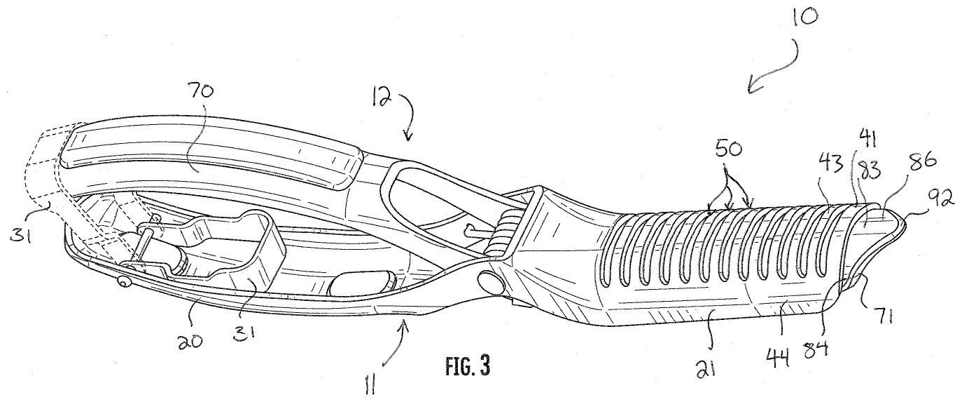

The sidewalls 26 and 27 cooperate with the endwall 28 and the medial wall 25 to define an interior space or hold 30 in the handle 20. Proximate the distal end 22, just inboard of the endwall 28, a latch 31 is mounted for swinging movement on a pin 32 fit between the sidewalls 26 and 27. The latch 31 moves between a first position, shown in FIGS. 1 and 2, in which the latch 31 is stowed in the hold 30, and a second position, shown in broken line in FIG. 3, in which the latch 31 is slipped over the second member 12 to hold it close to the first member 11.

The first member 11 extends forwardly from the handle 20 to the jaw 21. The jaw 21 is an elongate member extending from a proximal end 40 to a distal end 41. The proximal end 40 of the jaw 21 is located at the distal end 23 of the handle 20. The jaw 21 includes a single body 42 extending entirely from the proximal end 40 to the distal end 41. Moreover, the body 42 of the jaw 21 is a contiguous extension of the body 24 of the handle 20. The body 42 has a medial wall 43 and opposed sidewalls 44 and 45 flanking the medial wall 43.

The medial wall 43 is a roughly flat wall extending along, and forming, a back of the jaw 21. The medial wall 43 extends from the proximal end 40 to the distal end 41.

The sidewalls 44 and 45 also extend from the proximal end 40 to the distal end 41 on either side of the medial wall 43. They are arranged roughly normal to the medial wall 43 with curved transitions therebetween. The sidewalls 44 and 45 each depend from the medial wall 43 by roughly the same distance, shown as a double-arrowed line in FIG. 2 marked with the reference character 48.

The jaw 21 has an upper surface 46 and an opposed concave lower surface 47. The jaw 21 further includes a plurality of spaced-apart slots 50 formed entirely through the jaw 21 from the upper surface 46 to the lower surface 47. The slots 50 are slender, having a width dimension 51 shown in FIG. 1. The slots 50 extend broadly across the jaw 21, from one closed end on one sidewall 44, across the medial wall 43, to an opposed closed end on the other sidewall 45. Each slot 50 has a length which is normal to the width dimension 51 and which extends between the opposed closed ends of the respective slot 50.

The slots 50 are preferably coextensive to each other. The slots 50 are arranged in a spaced-apart fashion transversely between the proximal and distal ends 40 and 41 along the jaw 21. They are spaced apart from each other by a distance roughly corresponding to the width dimension 51.

Each slot 50 has a pair of edges directed toward an upper surface of a jaw on the second member 12. Referring now to FIG. 2, each slot 50 has a front edge 52 and an opposed back edge 53, formed by the intersection of the lower surface 47 of the jaw 21 and an inner wall 54 of the slot 50. The front and back edges 52 and 53 are long edges, extending fully along the length of the slot 50 between its closed ends. The inner wall 54 of the slot 50 and the lower surface 47 of the jaw 21 are roughly normal to each other, so that the edges 52 and 53 are sharp edges. The front edges 52 are directed downward and backward, or downward and toward the proximal end 40 of the jaw 21. The rear edges 53 are directed downward and forward, or downward and toward the distal end 41 of the jaw 21.

The embodiment of the tool 10 shown in these drawings has twelve slots 50. Other embodiments have a lesser or greater number of slots 50. The slots 50, with their front and back edges 52 and 53, provide the lower surface 47 of the jaw 21 with a non-smooth characteristic. In other embodiments of the tool 10, other structural elements and features provide the lower surface 47 of the jaw 21 with a non-smooth characteristic. For example, and without limitation, in other embodiments, the lower surface 47 is formed with holes, bores, alternately-arranged or -shaped slots, divots, channels, bumps, nubs, textures, ridges, knurling, interruptions, discontinuities, sand, sandpaper, adhesive, tacky material, materials with suitably high coefficients of friction, or other like features. The non-smooth characteristic improves the ability for the jaw 21 to hold onto a rib rack membrane without slippage. The non-smooth characteristic includes rough, uneven, pocky, pitted, serrated, wavy, bumpy, coarse, creased, and other structural elements, features, or finishes that are not smooth.

The jaw 21 of the first member 11 bounds and defines a hold 55. The hold 55 is disposed between the proximal and distal ends 40 and 41 of the jaw 21, and between the sidewalls 44 and 45. The hold 55 is sized and shaped to receive the jaw of the second member 12 when the first and second members 11 and 12 pivot into the closed position.

Between the handle 20 and the jaw 21 of the first member 11 is a yoke 60. The yoke 60 is a small bridge connecting the jaw 21 to the handle 20. The yoke 60 includes two sidewalls 61 and 62, which are contiguous extensions of both the sidewalls 26 and 27 and the sidewalls 44 and 45, respectively. There is an interior space or gap 63 between the two sidewalls 44 and 45. A pin 64 passes through the gap 63 and is secured with caps on the outside of the sidewalls 44 and 45. The pin 64 is the axis of pivotal movement for the first and second members 11 and 12 with respect to each other. A bias or spring 65, such as a torsion spring, is mounted on the pin 64 and disposed and compressed between the first and second members 11 and 12 to bias them into an open position apart from each other.

Still referring to FIGS. 1 and 2, the tool 10 also includes the second member 12, pivoted to the first member 11. The second member 11 has a handle portion or handle 70 at one end of the first member 11 and an opposed jaw portion or jaw 71 at an opposed end of the first member 11. The handle 70 and jaw 71 are preferably constructed from a single, integral, monolithic piece of material, such as a molded, extruded, stamped, or otherwise formed piece of plastic or metal.

The handle 70 is an elongate member extending from a proximal end 72 to a distal end 73. The handle 70 includes a single body 74 extending entirely from the proximal end 72 to the distal end 73. The body 74 has a medial wall 75 and opposed sidewalls 76 and 77 flanking the medial wall 75.

The medial wall 75 is a roughly flat wall extending along, and forming, a back of the handle 70. The medial wall 75 extends from the proximal end 72 but terminates short of the distal end 73. Offboard of the medial wall 75, between the medial wall 75 and the distal end 73 of the handle 70, is a gap 79.

The sidewalls 76 and 77 extend entirely from the proximal end 72 to the distal end 73 on either side of the medial wall 75. They are arranged roughly normal to the medial wall 75, though they are formed to the medial wall 75 with curved transitions therebetween. The sidewalls 76 and 77 are also formed to an endwall 78 at the proximal end 72 of the handle 70. The sidewalls 76 and 77 and the endwall 78 all depend from the medial wall 75 by roughly the same distance.

The second member 12 extends forwardly from the handle 70 to the jaw 71. The jaw 71 is an elongate member extending from a proximal end 80 to a distal end 81. The proximal end 80 of the jaw 71 is located at the distal end 73 of the handle 70. The jaw 71 includes a single body 82 extending entirely from the proximal end 80 to the distal end 81. Moreover, the body 82 of the jaw 71 is a contiguous extension of the body 74 of the handle 70. The body 82 has a medial wall 83 and opposed sidewalls 84 and 85 flanking the medial wall 83.

The medial wall 83 is a roughly flat wall extending along, and forming, a back of the jaw 71. The medial wall 83 extends from the proximal end 80 to the distal end 81.

The sidewalls 84 and 85 also extend from the proximal end 80 to the distal end 81 on either side of the medial wall 83. They are arranged roughly normal to the medial wall 83 with curved transitions therebetween. The sidewalls 84 and 85 each depend from the medial wall 83 by roughly the same distance, shown as a double-arrowed line in FIG. 2 marked with the reference character 88.

The jaw 71 has a convex upper surface 86 and an opposed lower surface 87. The upper surface 86 is smooth. It is preferably a generally continuous, even, uniform surface, free of interruptions, irregularities, discontinuities, impediments, bumps, raised or depressed textures, and is preferably free of slots, divots, channels, bumps, nubs, textures, ridges, knurling, interruptions, discontinuities, sand, sandpaper, adhesive, tacky material, materials with high coefficients of friction, or other like features. It feels smooth to the touch.

At the distal end 81 of the jaw 21 is a tip 90. The medial wall 83 extends further than do the sidewalls 84 and 85, thus forming a central nose 91. This nose 91 has a contoured profile marked by an edge 92. The edge 92 is preferably a bevel or chamfer between the upper surface 86 and the lower surface 87. The edge 92 projects outwardly furthest at the central nose 91, then tapers backward and downward along the sidewalls 84 and 85. The edge 92 is directed upward.

Between the handle 70 and the jaw 71 of the second member 12 is a yoke 93. The yoke 93 is a small bridge connecting the jaw 71 to the handle 70. The yoke 93 includes two sidewalls 94 and 95, which are contiguous extensions of both the sidewalls 76 and 77 and the sidewalls 84 and 85, respectively. There is an interior space or gap 96 between the two sidewalls 84 and 85. The gap 96 moves in and can occupy the same space as the gap 63 in the first member 11. The pin 64 which is secured in the sidewalls 61 and 62 of the first member 11 also passes through the sidewalls 94 and 95 and the gap 96.

In operation, the cook uses the tool 10 to both separate and remove a membrane from a rack of ribs. The tool 10 moves between an open position, shown in FIGS. 1 and 2, and a closed position, shown in FIGS. 3-5. In the open position, the cook can slide the jaw 71 between the membrane and the meat by inserting the edge 92 on the tip 90 of the jaw 71 between the membrane and the meat and moving the tool 10 forward along the meat surface. As the cook moves the tool 10, the edge 92 gently lifts and separates the membrane from the meat cleanly without risk of tearing. The smooth upper surface 86 of the jaw 71 allows the membrane to slide up and onto the jaw 71.

Once the cook has moved the tool 10 so that the membrane covers all or most of the upper surface 86 of the jaw 71, or the cook feels that he has slid the tool 10 far enough under the membrane, he closes the tool 10. He does this simply by squeezing the handles 20 and 70 together along the line 100 with sufficient force to overcome the bias of the spring 65. This brings the tool 110 into the closed position shown in FIGS. 3-5.

In the closed position, when a membrane is not captured between the jaws 21 and 71, the lower surface 47 of the jaw 21 of the first member 11 overlies and nests with the upper surface 86 of the jaw 71 of the second member 12. Preferably, the entirety of the lower surface 47 is in direct and flush contact with the upper surface 86. Preferably, the entirety of the upper surface 86 of the jaw 71 is in direct and flush contact with the lower surface 47 of the jaw 21, but for the upper surface 86 along the tip 90. Preferably, all of the slots 50 are in direct and flush contact with the upper surface 86, including the front and back edges 52 and 53. As noted above, the front and back edges 52 and 53 are directed toward the upper surface 86.

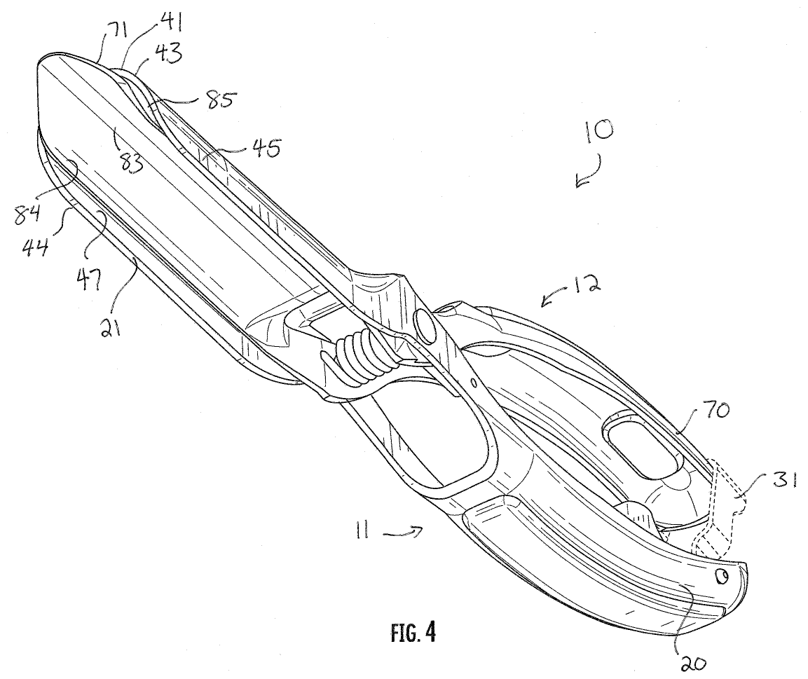

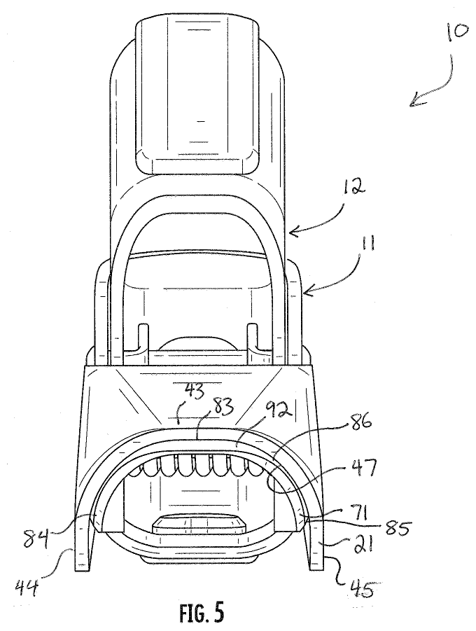

Moreover, in the closed position, the sidewalls 44 and 45 of the jaw 71 hang over the sidewalls 84 and 85. The sidewalls 44 and 45 extend the distance 48 (shown in FIG. 2) from the medial wall 43, and the sidewalls 84 and 85 extend the distance 88 (also shown in FIG. 2) from the medial wall 83. The distance 48 is greater than the distance 88. Thus, as best shown in FIGS. 4 and 5, the sidewalls 44 and 45 terminate below the sidewalls 84 and 85. In other words, in the closed position, the sidewalls 44 and 45 extend further below the medial wall 43 than do the sidewalls 84 and 85, such that the sidewalls 44 and 45 hang over and even substantially conceal the sidewalls 84 and 85 from a side view.

Still further, in the closed position, the distal end 81 of the jaw 71 projects beyond the distal end 41 of the jaw 21. The jaw 71 is slightly longer than the jaw 21, and so when the jaws 21 and 71 are moved into the closed position, the jaw 71 sticks out beyond the jaw 21. As shown in FIG. 3, the edge 92 is visible beyond the jaw 21.

When the cook closes the tool 10 on the membrane, he clamps the membrane between the lower surface 47 of the jaw 21 and the upper surface 87 of the jaw 71. The non-smooth characteristic of the lower surface 47 enhances the grip of the tool 10 on the membrane. The cook can now lift the tool 10 gently away from the rib rack, thereby pulling and removing the membrane off the meat without tearing it. When the cook has fully removed the membrane, he simply opens the tool 10 and drops the membrane into the trash. He can then slide the tool 10 under the membrane of another rib rack and repeat.

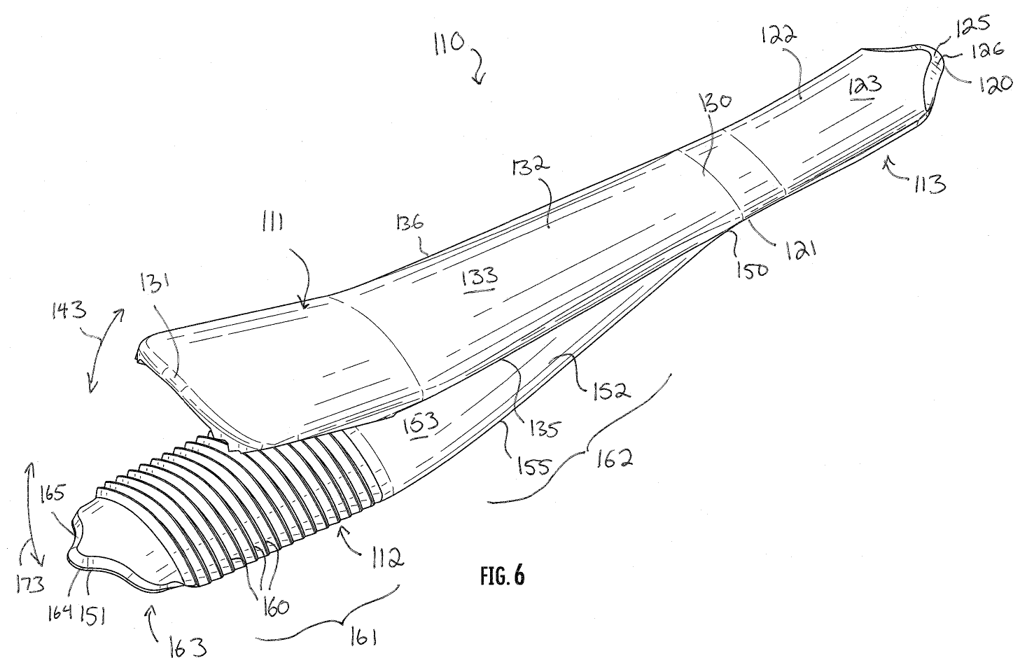

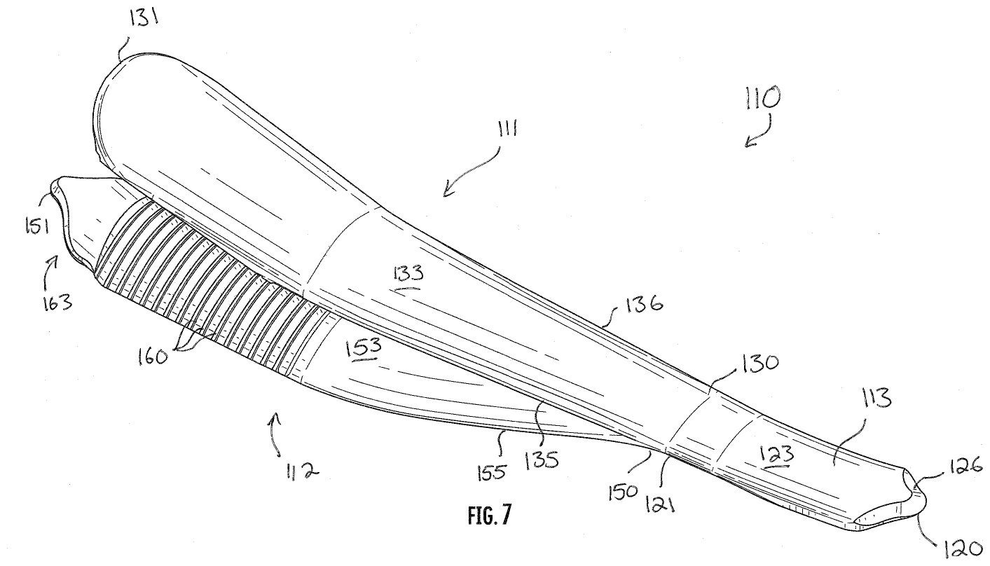

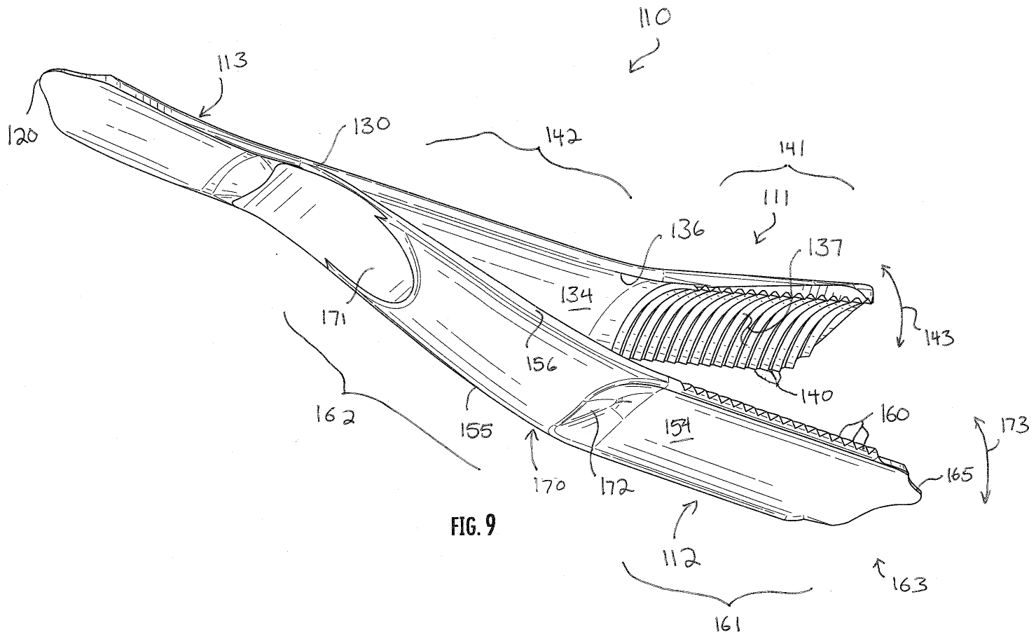

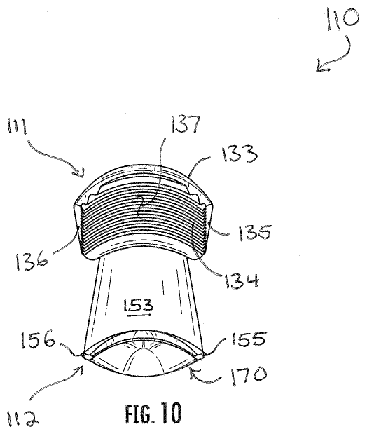

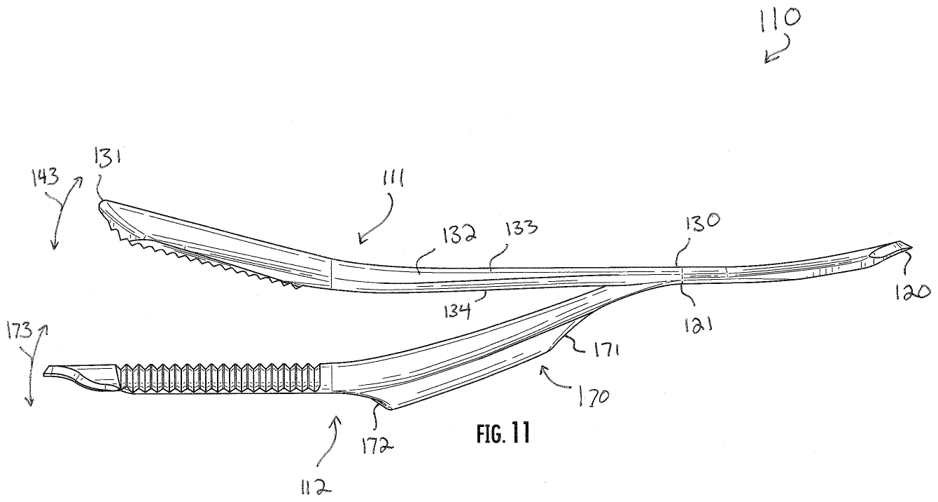

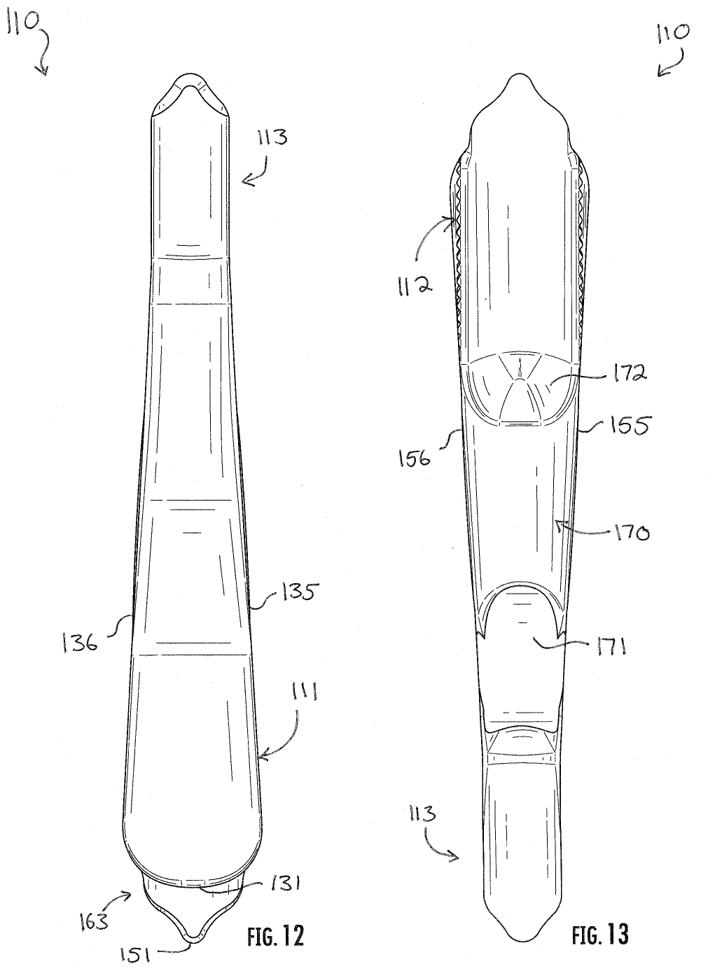

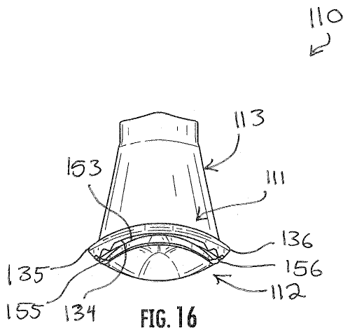

FIGS. 6-16 illustrate an embodiment of a rib preparation tool (hereinafter, the “rib prep tool 110” or just the “tool 110”) from alternate views, showing the tool 110 with jaws in open and closed positions. The tool 110 is preferably made of a resilient material, such as plastic, and includes two main members coupled to each other to resiliently flex between those open and closed positions. The tool 110 includes a first jaw 111, a second jaw 112, and a handle 113 to which both the first and second jaws 111 and 112 are integrally and monolithically formed. When a cook grasps the tool 110 and squeezes the jaws 111 and 112 together, the tool 110 moves to open and close its jaws. A cook uses the tool 110 to easily slide under the membrane on a rack of ribs, grasp the membrane, and separate and tear the membrane away from the rack without slipping and without dirtying his fingers or wasting a paper towel.

The handle 113 has a proximal end 120 and a distal end 121 with a preferably solid body 122 extending therebetween. The body 122 has a convex upper surface 123 and an opposed concave lower surface 124. The body 122 is relatively thin between the upper and lower surfaces 123 and 124, and it curves upward slightly from the distal end 121 to the proximal end 120.

The distal end 121 of the handle 113 has a central nose 125 that extends further distally than do sides of the handle 113 flanking the nose 125. The nose 125 has a contoured profile marked by an edge 126. The edge 126 is preferably a bevel or chamfer between the upper surface 123 and the lower surface 124. The edge 126 projects outwardly furthest at the central nose 125, then tapers back and downward along to the sides of the handle 113. The edge 126 is directed upward.

The handle 113 is a common handle; it is formed integrally and monolithically to both the first and second jaws 111 and 112, each of which project forwardly from the distal end 121 of the handle 113. The first jaw 111 is above the second jaw 112. Both of the jaws resiliently flex between the open and closed positions.

The first jaw 111 is an elongate member extending from the distal end 121 of the handle 113. The first jaw 111 has a proximal end 130 and opposed distal end 131. The proximal end 130 of the first jaw 111 is contiguous to the distal end 121 of the handle 113 and is thus a contiguous extension of the handle 113. The first jaw 111 includes a single body 132 extending entirely between the proximal and distal ends 130 and 131. The first jaw 111 has a convex upper surface 133 and an opposed concave lower surface 134. The upper and lower surfaces 133 and 134 meet at opposed left and right edges 135 and 136, named here only with respect to the manner in which the tool 110 is preferably held and not to limit the disclosure.

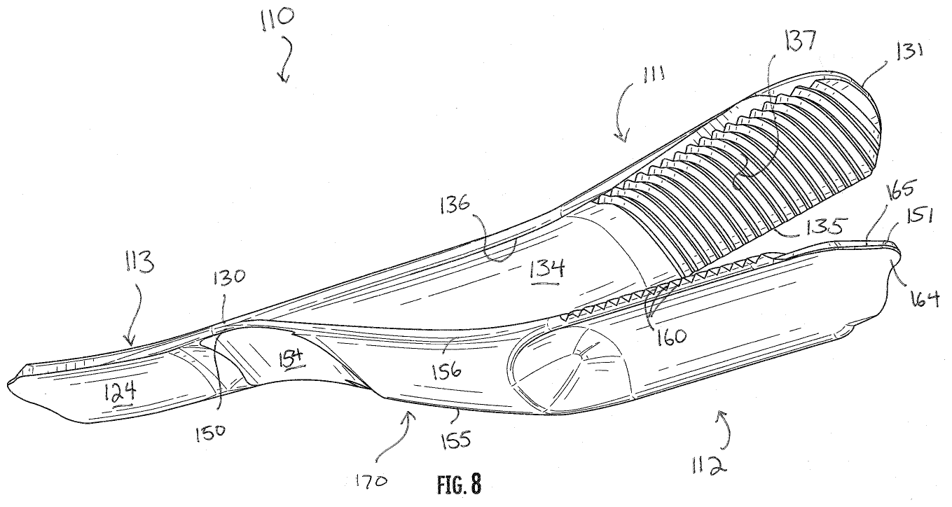

As shown perhaps best in FIGS. 8-10, the convex upper surface 133 is larger than and has a larger arc than the concave lower surface 134. The left and right edges 135 and 136 are directed both outward from the tool 110 and downward toward the second jaw 112. The left and right edges 135 and 136, together with the lower surface 134, bound an elongate, shallow hold 137 on the underside of the first jaw 111. The hold 137 extends from the proximal end 130 to the distal end 131 and between the edges 135 and 136 of the first jaw 111. The hold 137 is sized and shaped to receive the second jaw 112 when the jaws 111 and 112 are moved into the closed position.

The first jaw 111 further includes a plurality of spaced-apart ridges 140. The ridges 140 are downwardly-directed edges flanked by upwardly-directed valleys. The ridges 140 are arranged and spaced-apart transversely between the edges 135 and 136, meaning that each ridge 140 extends between the left edge 135 and the right edge 136. Like the lower surface 134 on which they are formed, the ridges 140 are concave between the edges 135 and 136. The ridges 140 begin at the distal end 131 of the first jaw 111 and terminate at an intermediate location between the proximal and distal ends 130 and 131, defining a non-smooth or ridged portion 141 of the first jaw 111. Proximal to that, or between the ridged portion 141 and the proximal end 130 of the first jaw 111, defined as a smooth portion 142, the lower surface 134 of the first jaw 111 is smooth. Thus, the first jaw 111 has both smooth and non-smooth portions with smooth and non-smooth characteristics, respectively.

In other embodiments, along the non-smooth or ridged portion 141, the lower surface 134 is formed with slots, holes, bores, slots, divots, channels, bumps, nubs, textures, knurling, interruptions, discontinuities, sand, sandpaper, adhesive, tacky material, materials with suitably high coefficients of friction, or other like features. The non-smooth characteristic improves the ability for the first jaw 111 to hold onto a rib rack membrane without slippage. The non-smooth characteristic includes rough, uneven, pocky, pitted, serrated, wavy, bumpy, coarse, creased, and other structural elements, features, or finishes that are not smooth.

Along the smooth portion 142, the lower surface 134 is preferably a generally continuous, even, uniform surface, free of interruptions, irregularities, discontinuities, impediments, bumps, raised or depressed textures, and is preferably free of slots, divots, channels, bumps, nubs, textures, ridges, knurling, interruptions, discontinuities, sand, sandpaper, adhesive, tacky material, materials with high coefficients of friction, and other like features. It feels smooth to the touch.

The first jaw 111 is constructed to resiliently flex along the arrowed line 143 in FIG. 6. When the cook grips the tool in his hand, he preferably does so by grasping the handle in his palm with his thumb disposed against the first jaw 111, such as against the upper surface 133 and his fingers under the second jaw 112. By closing his hand, he pushes down on the first jaw 111 from the upper surface 133, causing the first jaw 111 to flex and move downward along the arrowed line 143.

The second jaw 112 is also constructed to resiliently flex. The second jaw 112 is an elongate member extending from the distal end 121 of the handle 113. The second jaw 112 has a proximal end 150 and opposed distal end 151. The proximal end 150 of the second jaw 112 is contiguous to the distal end 121 of the handle 113 and is thus a contiguous extension of the handle 113. The second jaw 112 includes a single body 152 extending entirely between the proximal and distal ends 150 and 151. The second jaw 112 has a convex upper surface 153 and an opposed lower surface 154. The upper and lower surfaces 153 and 154 meet at opposed left and right edges 155 and 156, named here only with respect to the manner in which the tool 110 is held and not to limit the disclosure.

The second jaw 112 further includes a plurality of spaced-apart ridges 160. The ridges 160 are upwardly-directed edges flanked by downwardly-directed valleys. The ridges 160 are arranged and spaced-apart between the edges 155 and 156, meaning that each ridge 160 extends between the left edge 155 and the right edge 156. Like the upper surface 153 on which they are formed, the ridges 160 are convex between the edges 155 and 156. The ridges 160 begin just inboard of the distal end 151 of the second jaw 112 and terminate at an intermediate location between the proximal and distal ends 150 and 151, defining a non-smooth or ridged portion 161 of the second jaw 112. Proximal to that, or between the ridged portion 161 and the proximal end 150 of the second jaw 112, defined as a smooth portion 162, the lower surface 154 of the second jaw 112 is smooth. And distal to that, or between the ridged portion 161 and the distal end 151, is a tip 163.

In other embodiments, along the non-smooth or ridged portion 161, the upper surface 153 is formed with slots, holes, bores, slots, divots, channels, bumps, nubs, textures, knurling, interruptions, discontinuities, sand, sandpaper, adhesive, tacky material, materials with suitably high coefficients of friction, or other like features. The non-smooth characteristic improves the ability for the second jaw 112 to hold onto a rib rack membrane without slippage. The non-smooth characteristic includes rough, uneven, pocky, pitted, serrated, wavy, bumpy, coarse, creased, and other structural elements, features, or finishes that are not smooth.

Along the smooth portion 162 of the second jaw 112, the upper surface 153 is preferably a generally continuous, even, uniform surface, free of interruptions, irregularities, discontinuities, impediments, bumps, raised or depressed textures, and is preferably free of slots, divots, channels, bumps, nubs, textures, ridges, knurling, interruptions, discontinuities, sand, sandpaper, adhesive, tacky materials material, with high coefficients of friction, and other like features. It feels smooth to the touch.

Beyond the ridged portion 161, or distal thereto, is the tip 163. The tip 163 is an integral and monolithic part of the second jaw 112, but the upper surface 153 has a smooth characteristic at the tip 163. The tip 163 includes a central nose 164 which projects further distally than the rest of the tip 163 flanking the nose 164. The nose 164 has a contoured profile marked by an edge 165. The edge 165 is preferably a bevel or chamfer between the upper surface 153 and the lower surface 154. The edge 165 projects outwardly furthest at the central nose 164 and then tapers backward and downward to the left and right edges 155 and 156. The edge 165 is directed upward.

The lower surface 154 of the second jaw 112 is concave but for a bulbous portion 170 of the second jaw 112. Between the proximal end 150 and the bulbous portion 170, and between the bulbous portion 170 and the distal end 151, the lower surface is concave. However, at the bulbous portion 170, the lower surface projects downwardly in a convex fashion. This provides the second jaw 112 with some bulk. The cook can place his fingers under the bulbous portion 170 when the cook is preferably grasping the tool 110 with the handle 113. The bulbous portion 170 includes two sloped faces 171 and 172. The first sloped face 171, which is proximal to the bulbous portion 170, transitions from the smooth lower surface 154 extending from the proximal end 150 gently up to the bulbous portion 170. Similarly, the second sloped face 172, which distal to the bulbous portion 170, transitions from the bulbous portion 170 down to the smooth lower surface 154 along the ridged portion 161 of the second jaw 112. The bulbous portion 170 is preferably disposed in the ridged portion 162 and terminates short of the smooth portion 161.

Like the first jaw 111, the second jaw 112 is constructed to resiliently flex along the arrowed line 173 in FIG. 6. As noted above, when the cook grips the tool 110 in his hand, he preferably does so by grasping the handle 113 in his palm with his thumb disposed against the second jaw 111, such as against the upper surface 133, and with his fingers under the second jaw 112, such as against or around the bulbous portion 170. By closing his hand, he pushes down on the first jaw 111 from the upper surface 133 thereof and up on the second jaw 112 from the lower surface 154 thereof. This causes the first jaw 111 to flex and move downward along the arrowed line 143 and the second jaw 112 to flex and move upward along the arrowed line 173.

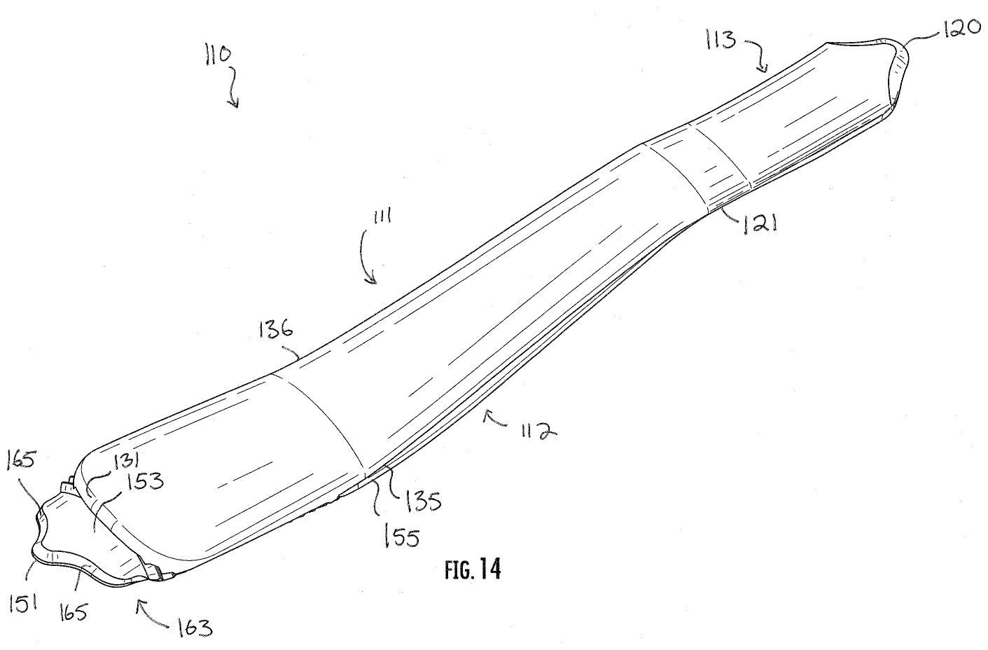

The first and jaws 111 and 112 are thus brought together into the closed position, such as shown in FIGS. 14-16. In the closed position, the lower surface 134 of the first jaw 111 overlies and nests with the upper surface 153 of the second jaw 112. Preferably, the entirety of the lower surface 134 is in direct and flush contact with the upper surface 153. Preferably, the entirety of the upper surface 153, but for that along the tip 163, is in direct and flush contact with the lowers surface 134.

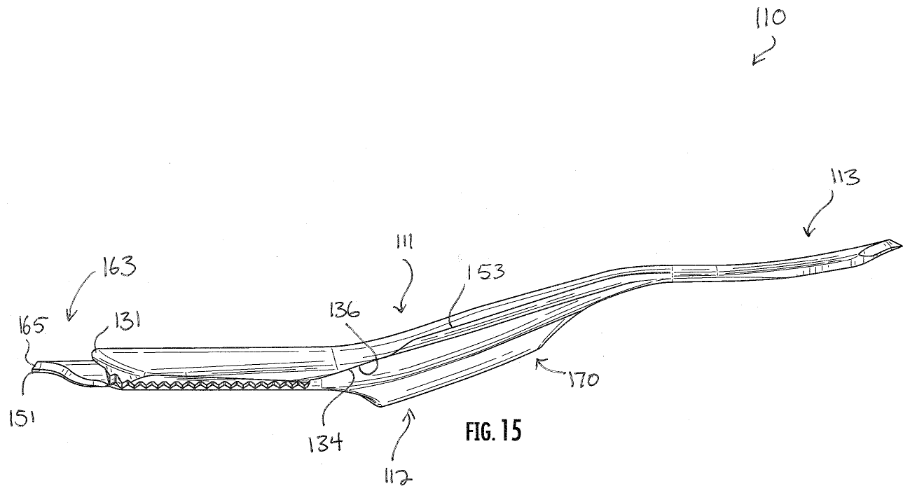

Moreover, in the closed position, the left and right edges 135 and 136 of the first jaw 111 are disposed laterally further outward than are the left and right edges 155 and 156 below them. The distal end 151 of the second jaw 112 projects beyond the distal end 131 of the jaw 111. The second jaw 112 is slightly longer than the first jaw 111, and so when the first and second jaws 111 and 112 are moved into the closed position, the jaw 112 sticks out beyond the jaw 111. As seen in FIGS. 14 and 15, the edge 165 is visible beyond the jaw 111.

In operation, when the cook wants to use the tool 110 to both separate and remove the membrane from a rack of ribs, he grasps the tool 110 as described above and allows it to move into an open position. Because the jaws 111 and 112 are resilient, the cook simply needs to loosely grasp the tool 110, and the jaws 111 and 112 will move into the open positions. The cook can then slide the second jaw 112 between the membrane and the meat by inserting the edge 165 on the tip 163 of the jaw 112 between the membrane and the meat and moving the tool 110 forward along the surface of the meat. As the cook moves the tool 110, the edge 165 gently lifts and separates the membrane from the meat cleanly without the risk of tearing. The membrane slides over the ridged portion 161 of the second jaw 112.

Once the cook has moved the tool 110 so that the membrane covers all or most of the upper surface 153 of the second jaw 112, or the cook feels that he has slid the tool 110 far enough under the membrane, he closes the tool 110. He does this simply by closing his hand and squeezing the two resilient jaws 111 and 112 together along the arrowed lines 143 and 173 into the closed position.

When the cook closes the tool 110 on the membrane, he clamps the membrane between the lower surface 134 of the first jaw 111 and the upper surface 153 of the second jaw 112. The membrane is clamped between the ridges 140 and 160, enhancing the tool's grip on the membrane. The cook can now lift the tool 110 gently away from the rib rack, thereby pulling and removing the membrane off the meat without tearing it. When the cook has fully removed the membrane, he simply opens the tool 110 and drops the membrane into the trash. He can then slide the tool 110 under the membrane of another rib rack and repeat.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

1. A rib preparation tool configured to remove a membrane from a rack of ribs, the rib preparation tool comprising:
a first jaw having a concave lower surface;
a second jaw having a convex upper surface, the first and second jaws mounted for movement with respect to each other between an open position, in which the upper surface of the second jaw is apart from the lower surface of the first jaw and is available to slide between the membrane and the rack of ribs, and a closed position, in which the lower surface of the first jaw overlies and nests with the upper surface of the second jaw to grip the membrane between the upper and lower surfaces; and
the lower surface of the first jaw has a non-smooth characteristic.

2. The rib preparation tool of claim 1, wherein the lower surface of the first jaw presents a plurality of edges directed toward the upper surface of the second jaw.

3. The rib preparation tool of claim 1, wherein the upper surface of the second jaw has a smooth characteristic.

4. The rib preparation tool of claim 1, wherein:
the first jaw has a first medial wall and opposed first sidewalls depending from the first medial wall;
the second jaw has a second medial wall and opposed first sidewalls depending from the second medial wall; and
in the closed position, the first sidewalls hang over the second sidewalls and terminate below the second sidewalls.

5. The rib preparation tool of claim 1, wherein:
the first jaw includes a first proximal end and an opposed first distal end;
the second jaw includes a second proximal end and an opposed second distal end; and
the second distal end projects beyond the first distal end.

6. The rib preparation tool of claim 5, wherein the second distal end includes a medial wall and opposed sidewalls flanking the medial wall, and the medial wall projects beyond the sidewalls.

7. A rib preparation tool configured to remove a membrane from a rack of ribs, the rib preparation tool comprising:
a first member comprising a first handle and a first jaw;
a second member comprising a second handle and a second jaw;
the first and second members pivoted to each other to move the first and second jaws between open and closed positions with respect to each other;
wherein the first jaw has a non-smooth concave lower surface, and the second jaw has a convex upper surface; and
in the open position of the first and second jaws, the upper surface of the second jaw is apart from the lower surface of the first jaw and is configured to slide between the membrane and the rack of ribs; and
in the closed position of the first and second jaws, the lower surface overlies and nests with the upper surface to grip the membrane between the upper and lower surfaces.

8. The rib preparation tool of claim 7, wherein the first jaw includes a plurality of spaced-apart slots.

9. The rib preparation tool of claim 8, wherein the first jaw includes a proximal end and an opposed distal end, and the slots are spaced apart transversely between the proximal and distal ends.

10. The rib preparation tool of claim 7, wherein:
the first jaw has a first medial wall and opposed first sidewalls depending from the first medial wall;
the second jaw has a second medial wall and opposed first sidewalls depending from the second medial wall; and
in the closed position, the first sidewalls hang over the second sidewalls and terminate below the second sidewalls.

11. The rib preparation tool of claim 7, wherein:
the first jaw includes a first proximal end and an opposed first distal end;
the second jaw includes a second proximal end and an opposed second distal end; and
the second distal end projects beyond the first distal end.

12. The rib preparation tool of claim 7, wherein the lower surface of the first jaw presents a plurality of edges directed toward the upper surface of the second jaw.

13. The rib preparation tool of claim 7, wherein the upper surface of the second jaw has a smooth characteristic.

14. The rib preparation tool of claim 7, further comprising a bias disposed between the first and second members biasing the first and second jaws into the open position.

15. A rib preparation tool comprising:
a first jaw having a non-smooth concave lower surface;
a second jaw having a convex upper surface;
the first and second jaws are both integrally formed to a common handle;
the first and second jaws resiliently flex between an open position and a closed position in which the lower surface of the first jaw overlies and nests with the upper surface of the second jaw; and
the second jaw includes a tip which, in the closed position of the first and second jaws, projects beyond the first jaw and includes a central nose with a contoured profile edge having an upwardly-directed bevel.

16. The rib preparation tool of claim 15, wherein the lower surface of the first jaw includes a plurality of spaced-apart ridges.

17. The rib preparation tool of claim 16, wherein the first jaw includes a proximal end and an opposed distal end, and the ridges are spaced apart transversely between the proximal and distal ends.

18. The rib preparation tool of claim 16, wherein the upper surface of the second jaw includes a plurality of spaced-apart ridges.

19. The rib preparation tool of claim 18, wherein:
the first jaw includes a first proximal end and an opposed first distal end, and the ridges are spaced apart transversely between the first proximal and distal ends; and
the second jaw includes a second proximal end and an opposed second distal end, and the ridges are spaced apart transversely between the first proximal and distal ends.

20. The rib preparation tool of claim 15, wherein:
the first jaw includes a first proximal end and an opposed first distal end;
the second jaw includes a second proximal end and an opposed second distal end; and
the second distal end projects beyond the first distal end.
